(19) United States
(12) Patent Application Publication
(10) Pub. No.: US 2010/0108707 A1
(43) Pub. Date: May 6, 2010

(54) Method and System For Customizing Bulk Purchases of Consumer Products

(76) Inventors: Marcille Faye Ruman, Oshkosh, WI (US); Jason R. Boon, Appleton, WI (US); Heidi L. Carey, Neenah, WI (US); Heidi Bauerlein Hopkins, Neenah, WI (US); George I. Nukuto, Neenah, WI (US); Abayomi Shonoiki, Brooklyn Park, MN (US); Louise C. Ellis Coe, Appleton, WI (US); Christian Hirthe, Appleton, WI (US); Charlcie Christie Kay Leitner, Appleton, WI (US); Heather Anne Sorebo, Appleton, WI (US); Nancy R. Ver Kuilen, Appleton, WI (US)

Correspondence Address: DORITY & MANNING, P.A., POST OFFICE BOX 1449, GREENVILLE, SC, 29602-1449, US

(21) Appl. No.: 12/262,929

(22) Filed: Oct. 31, 2008

(51) Int. Cl. A47F 3/02; G06Q 90/00; B62B 11/00

(52) U.S. Cl. 221/199; 705/500; 186/26

(57) ABSTRACT

A method and system of customizing bulk purchases of consumer personal care products are provided. In accordance with the present disclosure, multiple product forms and variants of the product forms may be contained within an integrated display within a retail outlet. The product forms may comprise any suitable personal care products, such as absorbent articles, feminine care products, toiletries, products for infants and children, adult incontinence products, tissue products, and the like. In accordance with the present disclosure, a consumer can select multiple packages based on personal preference that contain various different product forms and/or variants. The consumer is instructed to select a particular number of packages for purchase that total a single bulk price. In this manner, the consumer can take advantage of bulk pricing while still being able to select multiple related personal care products.

### BACKGROUND

In the relatively recent past, warehouse-type stores have evolved and become popular. In such types of stores, consumers can buy bulk purchases of products at a reduced price. For instance, in warehouse-type outlets and in various other types of outlets, consumers can purchase large quantities of personal care products, such as diapers, in relatively large bundles. Such bulk purchases may require a high cash outlay, but do provide financial incentives over the long term in comparison to purchasing small packages from conventional grocery stores.

Buying in bulk, however, can have its disadvantages especially for consumers purchasing personal care products, such as diapers and other absorbent articles. For example, the infant or child for which the purchase is made may transition to a larger size prior to consuming all of the products obtained in the bulk purchase. For parents that have more than one child, the bulk purchase becomes even more problematic, in that the parents must purchase two different large quantities and assume the risk that one of the children will outgrow the size contained in the bulk purchase. In view of the above, some consumers prefer to avoid bulk purchases even at lower prices.

Consequently, a need currently exists for a method and system for customizing bulk purchases of consumer personal care products so that consumers, for one bulk price, can purchase multiple related products.

### SUMMARY

In general, the present disclosure is directed to a method and system for offering shoppers the customization of bulk purchases of related personal care products.

For example, in one embodiment, the present disclosure is directed to a method of customizing bulk purchases comprising the steps of displaying at least two related personal care product forms in a retail outlet. At least one of the product forms contains at least two variants. Each product form and variant are packaged into packages. In one embodiment, each package can have the same value and therefore be assigned the same unit price. In order to make a purchase, a consumer is required to select a mandated number of packages in order to take advantage of a bulk price.

The method further includes the step of having the consumer select a plurality of packages for purchase. In one embodiment, the packages can be prebundled by the manufacturer or retailer that may, for instance, provide a variety of product forms for the consumer. Alternatively, the consumer can be free to select any number of the packages containing any product form or variant based on personal preference, as long as the sum of the prices of the packages totals a single bulk price. The bulk price is predetermined by the manufacturer, the wholesaler, or the retail outlet. The consumer is then charged the bulk price for the assortment of packages. Specifically, the bulk price is less than if the consumer were to purchase the individual packages separately.

As described above, the method is generally directed to at least two related personal care product forms and to variants thereof. As used herein, related personal care product forms are personal care products that are designed to accomplish the same tasks (i.e. diapers and other articles), or used in conjunction with each other (i.e. baby wipes in conjunction with diapers) or products sold to the same age group or products sold to the same gender (i.e. feminine care products). A variant of a product form, on the other hand, comprises a variation in the same product. For instance, a variant may comprise a different size, a different scent, an addition of an additive that does not significantly change the character of the underlining product, or the like.

For example, in one embodiment, the related personal care product forms may comprise absorbent articles for infants and children. In this embodiment, each product may have at least two variants that may comprise different product sizes. In an alternative embodiment, the related product forms may comprise a greater number of products, such as at least two product forms of diapers, swim pants, training pants, baby wipes, disposable washcloths, baby lotions, baby washes, or sunscreens for small children. Still other related product forms that may be used include feminine care products and tissue products.

In one embodiment, the method further includes the step of providing the consumer with a caddy that is designed to carry the packages. The caddy may be disposable or reusable. In one embodiment, the caddy may be designed such that the interior volume of the caddy becomes substantially full when an assortment of packages are assembled that total the bulk price. In one embodiment, for instance, the bulk price may comprise four times the unit price. For example, in this embodiment, the consumer will be required to select four packages for purchase if the packages all have the same unit price.

The present disclosure is also directed to a system for selling customized bulk purchases of personal care products to consumers. The system includes an integrated display for locating within a retail outlet. The integrated display displays at least two different product forms and at least two variants of at least one of the product forms as described above.

The system can further include a caddy dispenser containing a plurality of caddies for consumer use. In this manner, a consumer can select a caddy and then fill the caddy with a plurality of packages, based upon individual preference, that total the bulk price. The integrated display can include instructions for allowing consumers to mix and match the packages.

By using an integrated display, most of the product information, brand recognition, and other indicia of the products can be included on the display. In this manner, not much product information or graphics are required on the individual packages.

Other features and aspects of the present disclosure are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a perspective view of one embodiment of a system in accordance with the present disclosure;

FIG. 2 is a perspective view of one embodiment of a caddy that may be used in accordance with the present disclosure;

FIG. 3 is a perspective view of an alternative embodiment of a caddy that may be used in accordance with the present disclosure;

FIG. 4 is a diagram illustrating various packages that may be combined together for a bulk purchase in accordance with the present disclosure.

FIG. 5 is a perspective view of one embodiment of a package that may be used in accordance with the present disclosure.

FIG. 6 is a perspective view of another embodiment of a system that may be used in accordance with the present disclosure; and

FIG. 7 is a side view of still another embodiment of a system that may be used in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present invention.

In general, the present disclosure is directed to a method and system for customizing bulk purchases of related personal care products by consumers. Currently, at some retail outlets, consumers have the option of buying a single bulk package of personal care products that are all the same. By buying in large quantities, consumers can take advantage of a lower price per unit. In some instances, however, not only does the bulk purchase represent a large price outlay but may provide the consumer with more of the product than they need. In this regard, the present disclosure is directed to a system and method of marketing personal care products in which the consumer is allowed to purchase a pre-determined number of packages of related personal care products at a set price. By purchasing a plurality of packages together, the bulk price is at a lower price per unit of product versus buying the smaller packages separately.

For example, in one embodiment, the present disclosure is directed to a system that includes the novel integration of marketing synergistic and related personal care products. More particularly, according to the present disclosure, related personal care products and their variants can be offered together in a retail outlet. For instance, in one embodiment, a single display may be used that offers each of the product forms and their variants. In accordance with the present disclosure, the display should include at least two different product forms and at least one of the product forms should include two different variants. The product forms can comprise, for instance, any related personal care products. The product forms may include, for instance, absorbent articles such as diapers, training pants, swim pants, and the like. Other product forms may include wiping products, such as baby wipes, disposable washcloths, and similar products. Still other product forms may include various toiletry products, such as lotions, washes, sunscreens, and the like. The product forms contained in the display can comprise related personal care products. Related products, for instance, may be products used by a certain group of individuals, such as children and infants, may comprise products used by a particular gender, such as feminine care products, or may comprise products used in conjunction with one another, such as diapers and baby wipes.

In addition to at least two product forms, the display may include variants of the product form. Variants may comprise, for instance, size variation, which is particularly relevant for absorbent articles. Variants may also include the difference between product forms that are scented or unscented or product forms that contain additional additives or ingredients that do not significantly change the overall product. The product forms and variants can also be varied or rotated to provide an ongoing variety or seasonal offerings.

The product forms and their variants can be packaged separately or together in quantities that are smaller than typical bulk packages. In one embodiment, each package can have the same unit price. The bulk price, on the other hand, can be based on the consumer purchasing two or more of the packages. When each of the packages has the same unit price, the selection of packages to equal a bulk price is simplified. For example, the display in the store merely needs to communicate to consumers to pick a certain number of packages to take advantage of the cost savings based upon a bulk price.

Specifically, customers can be instructed to purchase multiple packages from the integrated display at a single bulk price. In this manner, the consumer is free to mix and match the different packages as long as the consumer selects the appropriate number of packages based on the bulk price offered at the display. For instance, a consumer can select packages containing different product forms and different variants based upon individual preference. The multiple product forms and variants can then be bundled together and purchased for a single bulk price that may provide cost savings for the consumer.

In one embodiment, a caddy may be provided to the consumer for collecting and transporting the packages. The caddy, for instance, may be designed so as to only hold a sufficient number of packages that equal the bulk price. In this manner, not only does the caddy assist the consumer in carrying the packages, but may also assist the consumer in selecting the right number of packages. As will be described in greater detail below, the caddy can be disposable or reusable.

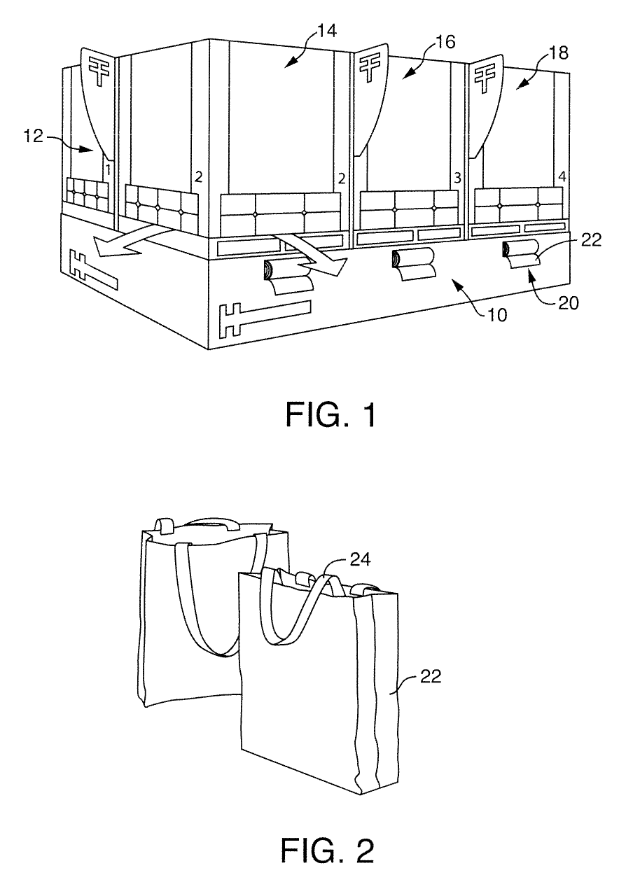

One embodiment of a system in accordance of the present disclosure, for instance, is illustrated in FIG. 1. As shown, the system includes an integrated display 10 that is configured to display, hold, and dispense a plurality of product forms and their variants. In this embodiment, for instance, the display 10 can include six different product receptacles such as the four product receptacles 12, 14, 16, and 18 shown in the Figure. It should be understood, however, that the display 10 can include more or less than six product receptacles. For instance, the display may include two product receptacles or more, such as from about two to about ten product receptacles. Each receptacle may include a different product form or variant. Alternatively, each receptacle may contain all the variants of a particular product form. The display 10 is integrated in that each product form and variant are associated with a single display.

The display 10 as shown in FIG. 1 can be leveraged to showcase the brand quality of the different product forms and variants with appealing graphics and interactive devices if desired. The display 10, for instance, can be synchronized and integrated with the packages to create a large billboard space within the retail outlet. The display can be configured to be placed prominently on the floor of the retail outlet or may be integrated into the aisles and racking system within the store. The display 10 can be permanent and refillable, semi-permanent and refillable, or disposable. The embodiment illustrated in FIG. 1, for instance, is intended to be re-supplied with product from the top of each product receptacle as the product is dispensed. Alternatively, each product receptacle 12, 14, 16, and 18 may be situated on a pallet that is completely removed and replaced on the base of the display as inventories begin to dwindle.

In addition to providing product information, advertising, and other information, the display 10 can also further include instructions in assisting consumers with making their bulk purchases. For instance, the display 10 can include instructions on how to select, handle, and bundle together the individual packages for paying a single bulk price. The instructions, for instance, may instruct consumers to pick a certain number of packages that will then total the bulk advertised price. The instructions can be printed on the display itself or can be provided by an electronic device such as a computer or kiosk. The instructions may be further used to guide the consumer through the selection of personal care products customized for their unique needs. For example, if the display contains absorbent articles, the display may assist a consumer in selecting size for their single child or multiple children and/or for selecting different products based on the child's characteristics. For instance, products worn at night may be matched with products worn during the day. In completing a purchase, a consumer will be required to select a minimum number of packages by purchasing multiple packages at a set price.

In one embodiment, the display 10 may also dispense bar codes that can be affixed to a bundle so that the entire bundle need only be scanned once during checkout at the retail outlet. Alternatively, each package can include its own barcode for scanning during checkout. Placing barcodes on all the packages may assist in inventory tracking to allow the retail outlet to determine the appropriate time to replenish particular product inventory.

The number of packages a consumer may be required to buy to achieve the advertised bulk prize may depend upon various factors. For instance, the number of packages selected may depend upon the related product forms that are contained in the display and the type of products that are contained in the display.

A consumer may then be required to select from about 2 to about 8 packages to have the packages total the bulk price.

As described above, in one embodiment, all the packages may have the same unit price which may simplify the process of selecting the appropriate number of packages that total the bulk price. Alternatively, however, the packages may have different prices. In this embodiment, the price of each package can be based on a single unit price that divides evenly into the bulk price. For example, in one embodiment, the display 10 may include packages that have the unit price, that have one-half the unit price and/or that have one-fourth the unit price.

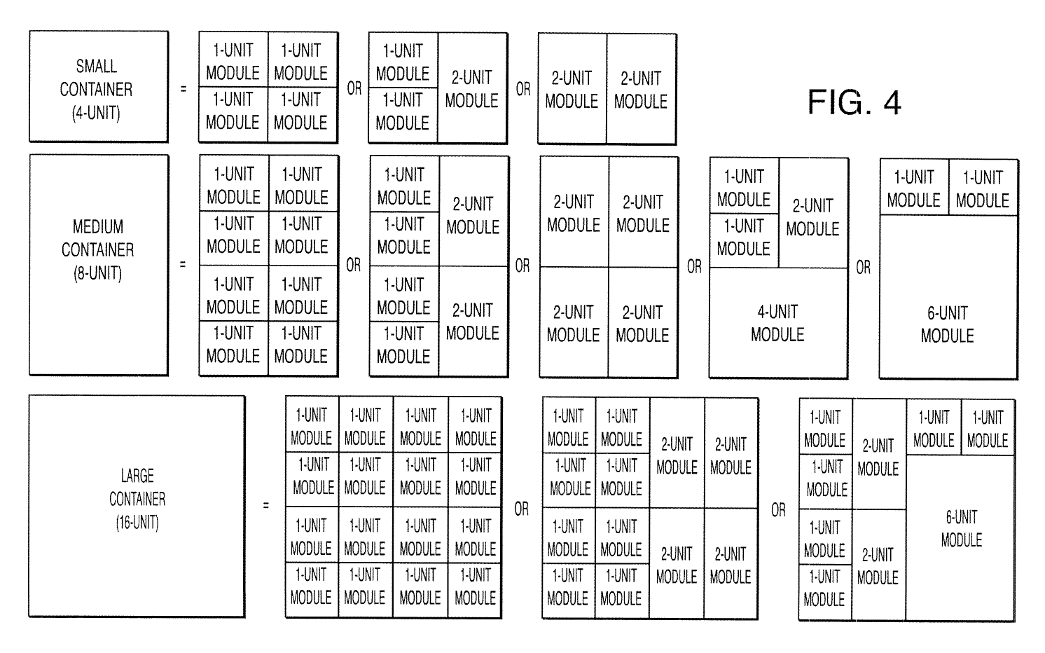

More specifically, referring to FIG. 4, a diagram is included that illustrates three different embodiments in which different packages are offered in the display. In the first embodiment, for instance, the bulk price is based on purchasing four modules. In this embodiment, the display can include one unit modules that are one-fourth the bulk price and two unit modules that are one-half the bulk price. In order to reach the bulk price, the consumer may then choose four one unit items, two one unit items and one two unit item, or two two unit items. The difference in price between the one unit module and the two unit module may be based on the quantity of the product in the package, based upon the quality of the product in the package, or may simply relate to the differences in the product form.

As shown in FIG. 4, the second embodiment illustrated is where the bulk price comprises the purchase of eight unit modules. In this embodiment, the display may contain one unit module packages that represent one eighth of the bulk price, two unit module packages that have a price that is one-fourth of the bulk price, four unit module packages that have a price that is one-half of the bulk price, and six unit module packages that have a price that is three fourths of the bulk price. As shown, different packages having different prices can be assembled in different manners to total the bulk price for purchase. As shown, the larger the bulk price and the more difference in price between packages, the more flexibility the consumer has in purchasing products. The system allows the streamlining of manufacturing operations while allowing consumers to mix and match products in combinations to meet their needs.

The third embodiment illustrated in FIG. 4 is directed to a bulk price based upon 16 unit module packages. As shown, in this embodiment, the display 10 may include packages that may have a price equal to one-sixteenth of the bulk price, one-eighth of the bulk price, or three-eighths of the bulk price. Other packages may also be included having different prices.

In one particular embodiment, the display 10 may include different bulk prices depending upon the number of packages purchased together. For instance, as shown in FIG. 4, in one embodiment, the system may include a four unit bulk price, an eight unit bulk price, or a sixteen unit bulk price. The sixteen unit bulk price, for instance, may have a reduced price per package than the four unit bulk price. However, different varieties of bulk prices may be available to the consumer depending upon the consumer's individual needs.

In order to assist shoppers in bundling the packages together in order to meet a specified bulk price, in one embodiment, each package contained within the display 10 can have a size that is proportional to the price of the package. For instance, a package that has a price that is equal to one-half the unit price may have a size that is one-half the size of a package that has a price of the full unit price. In this manner, as shown in FIG. 4, the packages can be assembled together in a single uniform bundle that totals the bulk price.

Referring to FIG. 1, in one embodiment, the display 10 can include a caddy dispenser 20 that holds a plurality of caddies 22 for consumer use. The caddies, for instance, can be designed to hold the plurality of packages that total the bulk price. The caddy, for instance, can assist the shopper in collecting and transporting the product from the retail store outlet to the checkout counter and to the car and into the home. The caddy may be disposable, reusable, or have an alternative purpose or secondary use. The caddy may comprise, for instance, a box, a carton, a bag, a handle that attaches to the packages, or any suitable means to contain and hold the packages together. The caddy, for instance, may be constructed from either a corrugate, paperboard, plastic, a woven material, a non-woven material, a plastic film, or a combination of any of the above materials. Reusable caddies may be offered for a one time purchase and reused by consumers.

In the embodiment illustrated in FIG. 1, the caddies 22 comprise plastic bags. In one embodiment, for instance, the plastic bags can have a volume such that any combination of packages that totals the bulk price substantially fills the volume of the caddy.

Referring to FIG. 2, an alternative embodiment of a caddy 22 is shown. In this embodiment, the caddy 22 comprises a bag having a handle 24. The bag is intended for reuse and can be made from woven materials, non-woven materials, or combinations thereof.

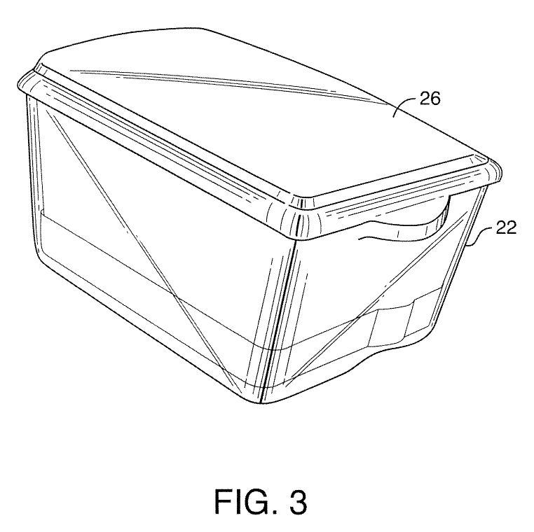

Referring to FIG. 3, still another embodiment of a caddy 22 is shown. In this embodiment, the caddy 22 comprises a container made from plastic or paperboard with a lid 26. The caddy 22 shown in FIG. 3 is intended to be reusable. In addition, the caddy shown in FIG. 3 is for placement in the home for storing and dispensing the product forms and variants contained within the packages that are loaded into the caddy or for any other purpose.

The caddy 22 as shown in FIG. 3, for instance, can be used as a storage bin. The storage bin can be designed so as to encourage consumers to reuse the caddy. In this regard, the storage bin can include attractive graphics and branding to convey that the storage bin is an easy-organizing extra for the consumer, shopper, and/or user. In one embodiment, for instance, the storage bin can include graphical elements designed to make the storage bin resemble a household item. For example, the addition of real or graphical hinges and pulls in coordinating graphics can make the storage bin resemble a chest, a dresser, a cabinet, a toy box, a toy, a wardrobe, a trunk, a jewelry box, or a similar item. In yet another embodiment, the storage bin can include non-product-identifying graphics that otherwise makes the storage bin attractive for use in the household.

As shown in FIG. 3, the storage bin can include a cover or lid 26. The cover can be either partially or completely removable from the storage bin and is capable of being reattached. The cover can be in the form of a single or multiple flaps.

In the embodiment illustrated, the storage bin is generally rectilinear, but can be any suitable shape. For example, the storage bin can also be cylindrical. In other embodiments, the footprint of the storage bin can be oval, a hemisphere, a triangle, a square, or any other shape including linear and/or arcuate portions.

As described above, the caddy or storage bin as shown in FIG. 3, can be manufactured from any suitable material. In addition, part or all of the storage bin can be opaque, translucent, or generally transparent and can be of any suitable color. In one embodiment, the storage bin can be manufactured from corrugate sturdy enough to support reuse.

There are many storage bin styles including but not limited to slotted boxes, telescoping boxes, folders, rigid boxes such as Bliss boxes, self-erecting boxes, corrugated common footprint containers and interior forms. Interior forms, such as liners, tubes, pads, build-ups, dividers, partitions and other inner packing pieces can be made in an infinite variety of ways to separate or cushion products to strengthen the storage bin or to fill voids to prevent products from moving.

In one embodiment, the storage bin can be made from corrugate and comprise a half-slotted storage bin and a tray as the cover. Half-slotted means that the storage bin has no top flaps. A Bliss box, which has no bottom flaps and which is similar to a standard shoe box, is also appealing to consumers because it eliminates gaps and the potential for the bottom to break open.

In other embodiments, windows or special cutouts can be added to the storage bin to enhance functionality or aesthetic appeal, including to add air vents to the storage bin.

The cover or lid can include a latching element to allow the cover to be positively attached to the storage bin bottom. The latching element can be any suitable mechanism, including adhesives, rigid or flexible tabs that engage a slot or other device, elements to allow the cover to be snapped onto the storage bin, a simple friction fit, hardware such as hinges and hasps, or any combination of these.

The packages that are contained in the dispenser 10 as shown in FIG. 1 can vary depending upon the particular type of product forms on display, the quantity of products contained in each package, and various other factors. The packages, for instance, can comprise polymer film packages, packages made from paper, packages made from paperboard, and combinations thereof. In some embodiments, especially when the product forms contain toiletry products, the packages may also comprise plastic containers such as plastic bottles.

Since the display 10 prominently advertises the products, in one embodiment, the packaging may contain a minimal amount of graphics and colors in order to minimize costs. For instance, the information contained on each package may comprise the brand name, the product form, the size, the count, or the navigation icon. The graphics, for instance, may comprise less than 50 percent of the surface area of the package, such as less than about 20 percent of the surface area of the package.

In other embodiments, however, if desired, the packages can include more prominent graphics and colors.

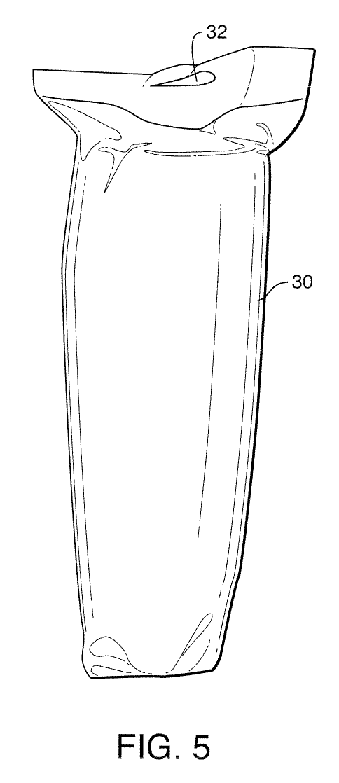

One embodiment of a package 30 that may be used in conjunction with the display 10 is shown in FIG. 5. As shown, the package 30 in this embodiment has a vertical height that is much larger than the width of the package. For instance, the vertical height can be at least three times the width of the package. The package can have an overall cylindrical shape as shown or can be rectangular in shape.

As shown in FIG. 5, the package 30 further includes a handle 32. In this embodiment, the handle 32 in integral with the package comprising an opening at a top margin of the package.

The package illustrated in FIG. 5 is well suited in use in conjunction with the display 10 as shown in FIG. 1. In particular, the package is easy to handle and has a size and shape to be easily bundled with other packages. For example, the package can easily be placed in a carrier with other packages of similar size and shape.

Although the package 30 as shown in FIG. 5 can be used to carry a variety of products, in one embodiment, the package 30 is for holding tissue products. For example, in one embodiment, the display 10 may contain a plurality of related product forms that comprise tissue products. Tissue products include facial tissues, bath tissues, paper towels, napkins, and wipes. Many of these products are contained in a spirally wound configuration, such as bath tissues and paper towels. Such products can be easily contained in the package 30 as shown in FIG. 5.

In addition to tissue products, the package 30 as shown in FIG. 5 is equally well suited for holding absorbent articles, such as diapers, training pants, swim pants, adult incontinence products, and feminine hygiene products.

In the example illustrated in FIG. 5, the package includes a vertical height that is larger than the width. In other embodiments, it should be understood that the package for use in the present system may have a height that can be substantially equal to the width or can have a height that is in any way greater than the width. Further, the height and the width can be greater than the depth. Alternatively, the depth can be substantially the same as the height and the width leading to a cube-like shape.

The packages contained in the display 10 may contain a single product form or may contain multiple product forms. For example, in one embodiment, the package 30 as shown in FIG. 5 may contain paper towels in conjunction with bath tissues. Various combinations of products can be contained in the package based on consumer preference.

In addition to being easily bundled with other packages, the package 30 also provides for prominence of the package at eye level when contained within the display.

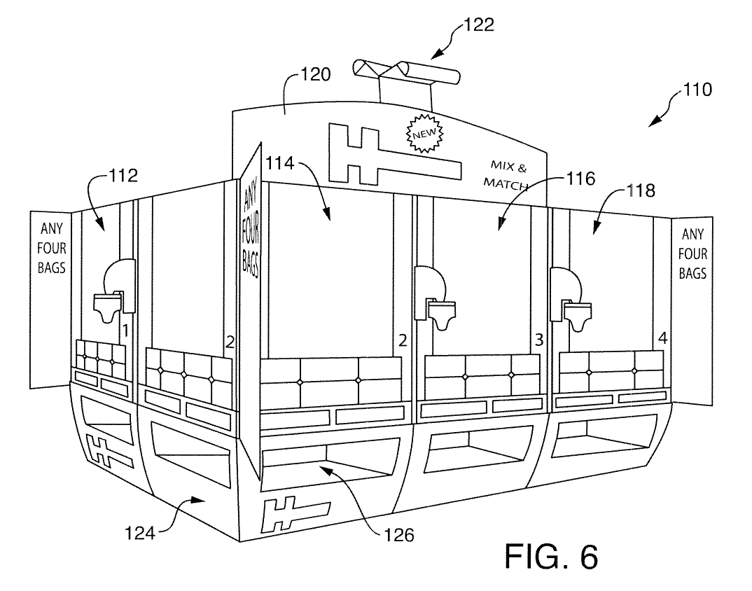

Referring now to FIG. 6, another embodiment of a display 110 that may be used with the present disclosure is shown. The display 110 is similar in appearance and function to the display 10 as shown in FIG. 1. The display 110 includes product receptacles 112, 114, 116, and 118. Each product receptacle can have the shape of a pallet that can be easily removed and replaced in the display for restocking product. Each product receptacle can gravity feed product packages to consumers. As shown in FIG. 6, the display 110 includes, in this embodiment, billboard space 120 for prominently advertising the product and providing instructions to consumers. The billboard space 120 can further include lights 122 for illuminating the display. Banners can also be located around the display for providing further information about the product forms.

The display 110 as shown in FIG. 6 includes a base 124 that defines a plurality of openings 126. The openings 126 can be for storing unwanted pulled product or can be used for any other purpose. For example, the openings 126 can also be used to hold caddies for collecting packages from the display.

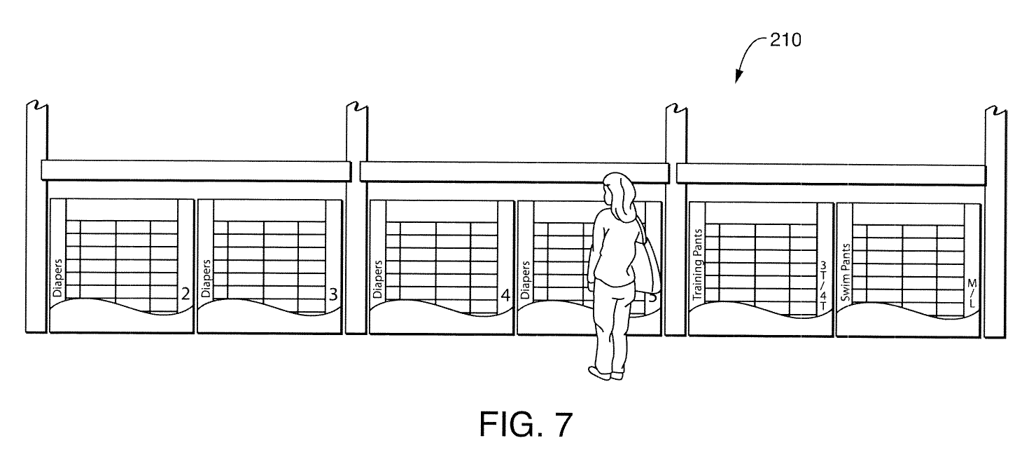

The displays illustrated in FIGS. 1 and 6 have a rectangular configuration in which products can be pulled from multiple sides of the display. Referring to FIG. 7, still another embodiment of a display 210 made in accordance with the present disclosure is shown. In the embodiment illustrated in FIG. 7, the product forms and variants are contained in a display which is intended to fit directly within an aisle of a retail outlet. As shown, the packages are all dispensed from a single side of the display. The packages may be contained on pallets for replenishing the stock.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A method of customizing bulk purchases of consumer personal care products comprising:
displaying at least two related personal care product forms in a retail outlet, at least one of the product forms including at least two variants, each product form and variant being packaged into packages, each package having an equal value based on a unit price;
having consumers select a plurality of the packages for purchase, the consumer being free to select any of the packages containing any of the product forms or variants based on individual preference as long as the sum of the unit prices of the packages total a single bulk price; and
charging the consumer the bulk price for the assortment of packages.

2. A method as defined in claim 1, wherein the related personal care product forms comprise absorbent articles for infants and children.

3. A method as defined in claim 1, wherein the at least two related product forms comprise at least two of diapers, swim pants, training pants, baby wipes, disposable washcloths, baby lotions, baby washes, or sunscreens.

4. A method as defined in claim 3, wherein at least one of the product forms comprises an absorbent article for infants or children and the two variants of the one product form comprise different product sizes of the absorbent article.

5. A method as defined in claim 1, wherein the two related personal care product forms comprise feminine care products.

6. A method as defined in claim 1, wherein the single bulk price is based on purchasing four packages.

7. A method as defined in claim 2, wherein each absorbent article includes at least two variants, the variants comprising different sizes.

8. A method as defined in claim 1, further comprising the step of providing the consumer with a caddy that holds the selected packages for purchase.

9. A method as defined in claim 1, wherein the single bulk price is based on purchasing from 2 to 8 packages.

10. A method as defined in claim 9, further comprising the step of providing the consumer with a caddy for holding the selected packages for purchase and wherein the packages have sizes such that any combination of packages that totals the single bulk price substantially fills the volume of the caddy.

11. A method as defined in claim 2, wherein the related personal care product forms further comprise wiping products.

12. A method as defined in claim 1, wherein at least certain of the packages have a vertical height and a width and wherein the vertical height is greater than the width of the package, the packages including a handle at the top of the package.

13. A method as defined in claim 12, wherein the packages have a vertical height that is at least about 3 times greater than the width of the package.

14. A system for selling customized bulk purchases to consumers comprising:
an integrated display for locating within a retail outlet, the integrated display including at least two different product forms, at least one of the product forms including at least two variants, each product form and variant being packaged into packages, each package having equal value based on a unit price; and
a caddy dispenser in association with the integrated display, the caddy dispenser containing a plurality of caddies for consumer use; and
instructions associated with the integrated display indicating to the consumers that they are free to select any of the packages containing any of the product forms or variants based on individual preference as long as the number of selected packages total a mandated single bulk price.

15. A system as defined in claim 14, wherein the single bulk price is based on selecting 2 to 8 packages.

16. A system as defined in claim 14, wherein the related personal care product forms comprise absorbent articles for infants or children.

17. A system as defined in claim 14, wherein at least the two product forms comprise at least two of diapers, swim pants, training pants, baby wipes, disposable washcloths, baby lotions, baby washes, or sunscreens.

18. A system as defined in claim 14, where at least one of the product forms comprise an absorbent article for infants or children and the two variants of the one product form comprise different sizes of the absorbent article.

19. A method of customizing bulk purchases of consumer personal care products comprising:
displaying at least two related personal care product forms in a retail outlet, at least one of the product forms including at least two variants, each product form and variant being packaged into packages, each package having a price based on a unit price such that each package has a price of the unit price, one-half of the unit price, or one-fourth of the unit price;
having consumers select a plurality of the packages for purchase, the consumer being free to select any number of the packages containing any of the product forms or variants based on individual preference as long as the sum of the prices of the packages total a single bulk price; and
charging the consumer the bulk price for the assortment of packages.

20. A method as defined in claim 19, wherein the related personal care product forms comprise absorbent articles for infants and children.

21. A method as defined in claim 19, wherein the at least two related product forms comprise at least two of diapers, swim pants, training pants, baby wipes, disposable washcloths, baby lotions, baby washes, or sunscreens.

22. A method as defined in claim 3, wherein at least one of the product forms comprises an absorbent article for infants or children and the two variants of the one product form comprise different product sizes of the absorbent article.
